(19) United States
(12) Patent Application Publication
(10) Pub. No.: US 2022/0343121 A1
(43) Pub. Date: Oct. 27, 2022

(54) APPLICATION OF LOCAL INTERPRETABLE MODEL-AGNOSTIC EXPLANATIONS ON DECISION SERVICES

(71) Applicant: RED HAT, INC., Raleigh, NC (US)

(72) Inventors: Daniele Zonca, Vignate (IT); Tommaso Teofili, Rome (IT)

(21) Appl. No.: 17/240,631

(22) Filed: Apr. 26, 2021

(51) Int. Cl. G06K 9/62

(52) U.S. Cl. CPC G06K 9/6269; G06K 9/6256; G06K 9/6219; G06K 9/6286

(57) ABSTRACT

A method includes receiving input data associated with an application, the input data including at least one complex object and converting the at least one complex objects of the input data to a linearized set of features. The method further includes performing an explainability service on the application in view of the linearized set of features of the at least one complex object to generate an explanation array.

### TECHNICAL FIELD

Aspects of the present disclosure relate to software explainability techniques, and in particular, to applying explainability techniques for black box AI systems to decision services.

### BACKGROUND

Explainability techniques, also referred to as explainable artificial intelligence (XAI), is a research area of artificial intelligence (AI) that attempts to make opaque AI systems more interpretable and understandable for human users and stakeholders. Decision services are systems that provide recommendations (i.e., decisions) to a user based on input data provided to the decision service.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for applying an explanation service to a black-box application, in accordance with some embodiments.

FIG. 2 is a block diagram that illustrates another example of a system for applying a LIME algorithm to a decision service, in accordance with embodiments of the disclosure.

FIG. 3 is a block diagram illustrating a system for applying an explainability service to an application by linearizing complex objects, in accordance with some embodiments.

FIG. 4 is a flow diagram of another method of applying an explanation service to a decision service, in accordance with some embodiments.

FIG. 5A is a block diagram illustrating a tree structure of a complex object, in accordance with some embodiments.

FIG. 5B is a block diagram illustrating a linearized object generated by linearizing a complex object, in accordance with some embodiments.

FIG. 6 is a block diagram of an example apparatus that may perform one or more of the operations described herein, in accordance with some embodiments of the present disclosure.

### DETAILED DESCRIPTION

Decision services, like AI systems, can be difficult to interpret and understand due to long lists of rules, complex or deep decision trees, and so forth. Additionally, decision services may integrate AI systems to produce the decision output results which can add to the complexity of a decision service, making the process even less transparent. Explainability services, such as local interpretable mode-agnostic explanations (LIME), can provide information about the underlying operation of a black-box AI model. The information provided by an explainability service may make the underlying AI systems more understandable, and therefore more trustworthy to human users, particularly in sensitive processes that directly affect humans in their real lives. A LIME service may receive linear feature sets (e.g., as tabular data or text data) as input from an AI system and provide interpretable information about the operation of the AI system in view of the AI system's use of the linear feature set. Decision services, however, often utilize complex domain specific inputs which a LIME service may be unable to ingest. For example, decision services, such as Decision Model and Notation™ (DMN™), may include composite and hierarchically organized input entities (e.g., complex objects). Accordingly, conventional LIME services that intake linear feature sets may not be executable on decision services that use complex object inputs.

Aspects of the disclosure address the above-noted and other deficiencies by providing a process for applying LIME techniques to decision services. To apply a LIME service to a decision service, processing logic may linearize complex objects used by a decision service to provide a linearized feature set that is compatible with the LIME service. For example, a taxonomy converter may operate with the LIME service to receive complex objects of a decision service and convert the complex objects to a linearized feature set (referred to herein as a “linearized object”) that can be used by the LIME service. The LIME service may generate importance scores (e.g., weights) for each of the features of the linearized object and then convert the linearized object and the corresponding importance score for each feature of the linearized object to the original structure of the complex objects received from the decision service.

In one example, the LIME service may receive the linearized object and generate perturbed instances of the linearized object. The LIME service may then convert the perturbed instances of the linearized objects to the original complex object format (e.g., via the taxonomy converter) and generate an output for each of the resulting complex objects of the perturbed instances of the linearized object. The LIME service may further generate sparse objects from the perturbed linearized objects and the generated outputs for each perturbed object to train a linear model with weights for each feature of the linearized object. The LIME service may associate the weights with the corresponding features of the linearized object and then use the defined taxonomy to assign the weights to the corresponding features of the original complex object. Accordingly, the LIME service provides an importance (i.e., a probability) of each feature in providing the output result.

In one example, the taxonomy converter of the LIME service may use a defined taxonomy associated with the decision service to identify and linearize features of complex objects. For example, the taxonomy converter may perform a linearization algorithm using the defined taxonomy to identify every feature and a type of every feature of the complex object. For example, the taxonomy converter may perform a depth-first linearization on a tree structure representing the complex object to identify and linearize each feature in the complex object. Similarly, the taxonomy converter may use the defined taxonomy to revert the linearized objects to the original form of the complex object. Accordingly, the taxonomy converter may provide LIME services with the capability to be applied to decision services or other opaque systems that utilize complex objects.

Thus, embodiments of the present disclosure provide for increased flexibility in the application of LIME services to additional applications that use complex data types. Additionally, the taxonomy converter may be adjusted or changed to expand compatibility to additional complex objects as needed, providing for further flexibility.

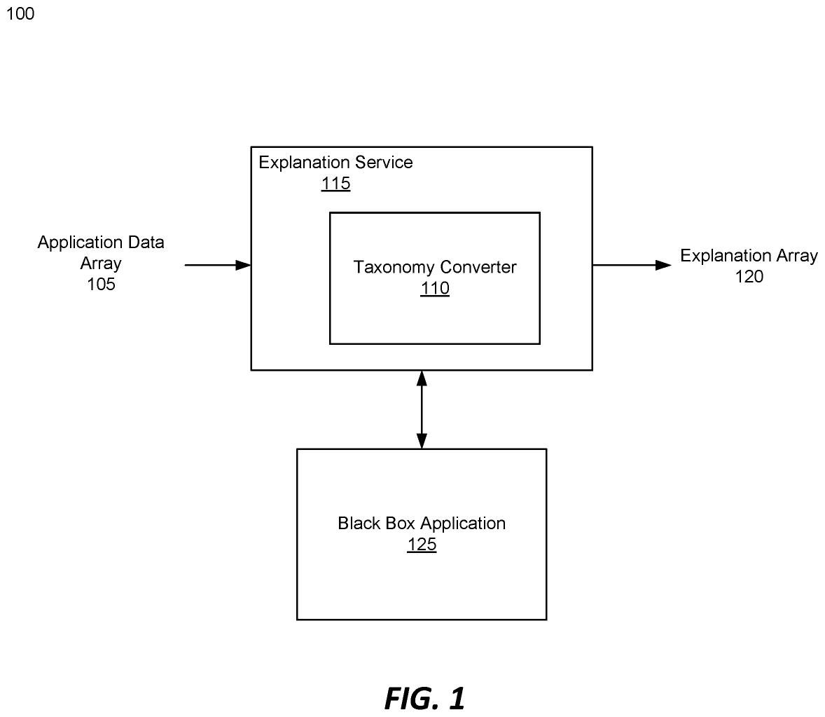

FIG. 1 is a block diagram illustrating an example system 100 for applying an explanation service to a black-box application. System 100 includes explanation service 115 and black-box application 125. Explanation service 115 may be a LIME algorithm for identifying information illustrating why the black-box application 125 provides particular outputs. The black-box application 125 is a decision service for outputting a decision recommendation based on provided input. In one example, the explanation service 115 may monitor execution of the black-box application 125 and identify the feature sets (e.g., application data array 105) input into the black-box application 125. The explanation service 115 may generate a local model of the black-box application 125 and execute the local model using different variations of the application data array 105. The explanation service 115 may then use the results of the execution of local model with the varied inputs to provide an explanation array 120 including the reasons the black-box application 125 provides a particular output. For example, the local model may be a linear model trained with the varied inputs to generate weights for each of the features of the linearized objects from the application data array 105. The weights for each feature may indicate a corresponding importance score for each feature.

In one example, the explanation service 115 includes taxonomy converter 110. In some examples, explainability service 115 may need a linear feature set to perform the functions described above. Accordingly, taxonomy converter 110 may identify complex objects in the application data array 105 and convert the complex objects of the application data array 105 to a linearized object on which the explainability service 115 may be performed. The taxonomy converter 110 may also convert the output of the explanation service 115 back into the original complex objects (e.g., explanation array 120) along with corresponding importance scores for each feature of the complex objects.

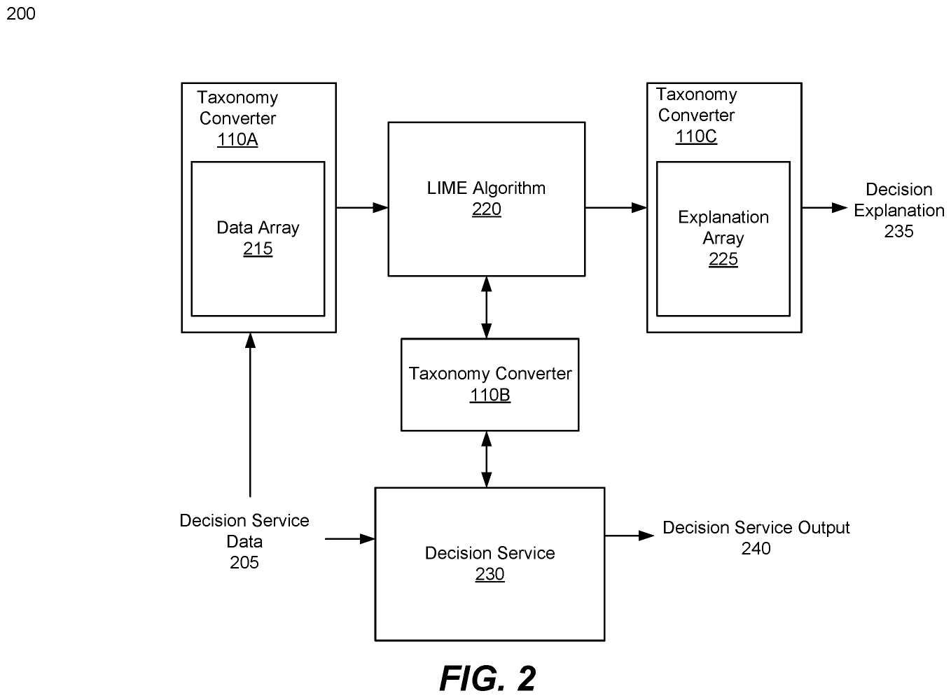

FIG. 2 is a block diagram illustrating a system 200 for applying a LIME algorithm to a decision service. System 200 includes decision service 230, taxonomy converter 110A-C and LIME algorithm 220. The decision service 230 may be a DMN™ service and may perform recommendations based on input data. For example, the decision service 230 may generate recommendations for patient treatment based on medical information of the patient. The decision service 230 may be performed for any other type of input data, service, or circumstance. Although depicted as separate components, taxonomy converters 110A-C may be a single component of the LIME algorithm 220. For example, the LIME algorithm 220 may monitor decision service data 205 that is used as input to the decision service 230. The decision service data 205 may include one or more complex objects. The taxonomy converter 110A may receive the decision service data 205 and convert the decision service data 205 into data array 215. The data array 215 may be a linearized object of the complex objects of decision service data 205.

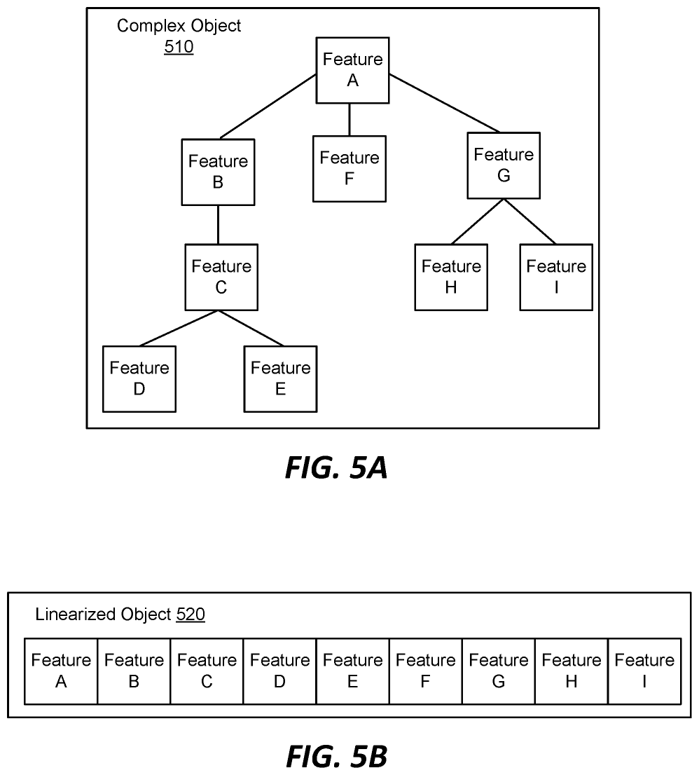

In one example, taxonomy converter 110A may identify a taxonomy associated with the decision service data 205 used by the decision service 230. For example, the taxonomy may define the types of features included in the decision service data 205 (e.g., String, Numeric, Boolean, URI, Time, Binary, Duration, Categorical, Vector, Currency, Composite, Nested, etc.). The taxonomy converter 110A may then use the defined taxonomy to identify each feature, including features that include or represent other features (i.e., composite or nested features). Thus, the taxonomy converter 110A may linearize complex objects of the decision service data 205 using the defined taxonomy to identify each feature of the complex objects. In one example, the taxonomy converter may perform a depth-first linearization on a tree structure representing a complex object to identify and linearize each feature in the complex object, as further described below with respect to FIG. 5.

The LIME algorithm 220 may then use the data array 215 to generate an explanation array 225. To generate the explanation array 225, the LIME algorithm 220 may sample the data array 215 and generate multiple perturbations of the data array 215 to be provided as input to the decision service 230. The perturbations of the data array 215, however, may be in a linearized format used by the LIME algorithm 220 which may be incompatible with the decision service 230. Accordingly, the taxonomy converter 110B may convert the perturbations of the data array 215 to the original complex format of the decision service data 205. The decision service 230 may then be applied to each of the perturbations to generate an output for each of the perturbations. The outputs of the decision service 230 for each of the perturbations of the data array 215 may then be provided back to the LIME algorithm 220.

The LIME algorithm 220 may generate and use sparse copies of the perturbations of the data array 215 and the outputs from the decision service 230 to train a linear classification model in a feature space. The resulting linear model may include a weight for each feature of the data array 215. The corresponding weight for each feature of the data array 215 may be an importance score indicating a probability that the feature affects the outcome of the decision service 230. The LIME algorithm 220 may associate the importance scores with each of the corresponding features of the data array 215 to generate the explanation array 225. The taxonomy converter 110C may then convert the explanation array 225 to the original format of the decision service data 205 (e.g., including complex objects) to generate a decision explanation 235 for the decision service 230. The decision explanation 235 may indicate why (e.g., what features were used) to generate the decision service output 240 from the input decision service data 205.

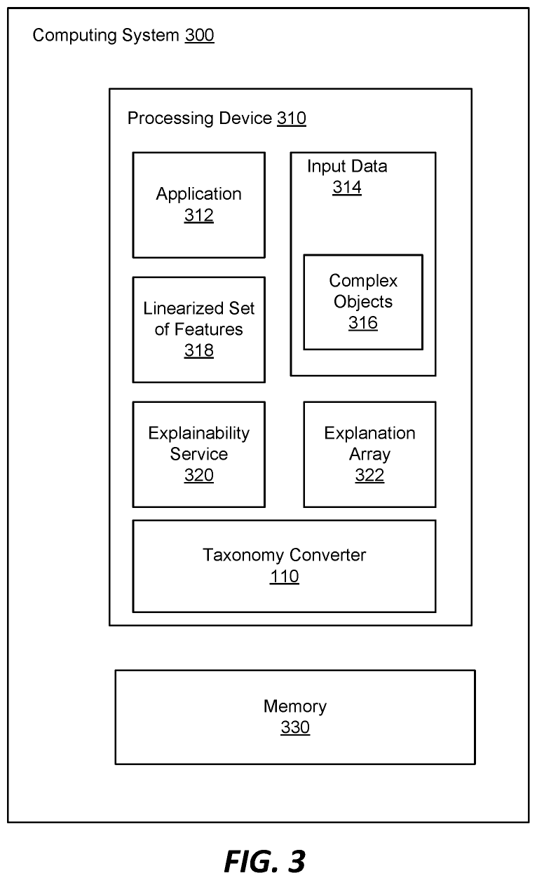

FIG. 3 is a block diagram illustrating a computing system 300 for applying an explainability service to an application (e.g., decision service) by linearizing complex objects. Computing system 300 includes processing device 310 and memory 330. Memory 330 may include volatile memory devices (e.g., random access memory (RAM)), non-volatile memory devices (e.g., flash memory) and/or other types of memory devices. Processing device 310 may include an application 312, input data 314 including complex objects 316, a linearized set of features 318, explainability service 320, explanation array 322, and taxonomy converter 110.

In one example, an explainability service 320 may be performed on the application 312. Explainability service 320 may be a LIME algorithm, or other explainabilty service and the application 312 may be a decision service, or other application with domain specific data objects (e.g., complex data objects). When the explainability service 320 is to be performed on the application 312, processing logic (e.g., taxonomony converter 110) may identify the input data 314 including complex objects 316 that is used as input to the application 312 (e.g., for a decision or recommendation to be made by the application 312). The explainabilty service 320 may be unable to be performed on the complex objects 316 and other domain specific data of the input data 314 as provided by the application 312. Thus, the taxonomy converter 110 may convert the complex objects 316 into a linearized set of features 318 that can be used to perform the explainability service 320 (e.g., LIME algorithm). The explainabilty service 320 as performed on application 312, using the linearized set of features, may then generate an explanation array 322. Explanation array 322 may include the linearized set of features 318 with corresponding weights of the features associated with an impact the feature had on a resulting output of the application 312. The taxonomy converter 110 may then convert the explanation array 322 into the original form of the input data 314, including the complex objects 316, to illustrate how the features of the complex objects 316, and other features of the input data 314, affect the resulting output of the application 312.

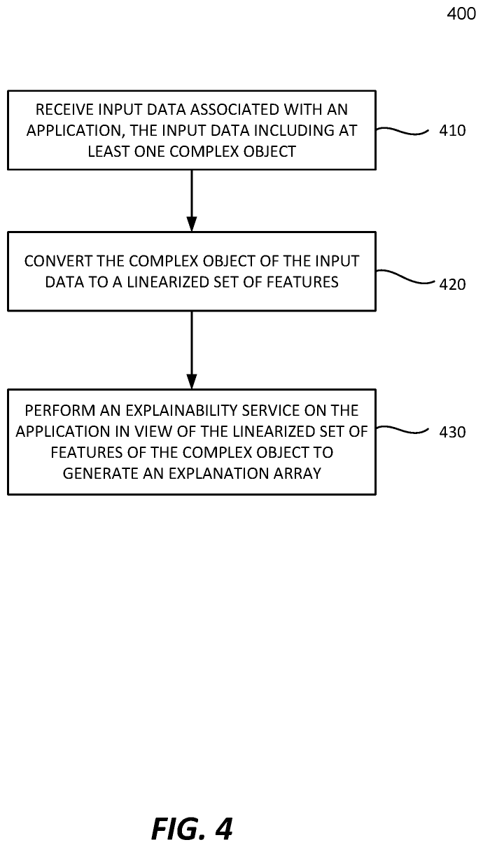

FIG. 4 is a flow diagram of a method 400 of applying an explanation service to a decision service, in accordance with some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by a taxonomy converter 110 of FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic receives input data associated with an application, the input data including at least one complex object. In one example, the application may be a decision service, such as a DMN™. In another example, the application may be any application that uses domain specific data, or any other non-linear complex objects or data structures. The complex object may be an object that includes one or more composite features, nested features, or any other type of complex data structure. For example, a composite feature may be a feature that represents multiple other features. A nested type feature may be a feature that includes one or more hierarchical features that depends from the nested type feature. In one example, the input data may include multiple complex objects.

At block 420, the processing logic converts the at least one complex object of the input data to a linearized set of features. In one example, to convert the complex objects of the input data to the linearized set of features, the processing logic may determine a taxonomy to be used by an explainability service based on the application input types and structure. The processing logic may then convert the complex objects to the linearized set of features using the taxonomy. For example, the taxonomy may include a definition of each type of feature used by the decision service and information about each type of feature, such as whether the feature represents or includes additional features. In one example, the taxonomy for a decision service may include: String, Numeric, Boolean, URI, Time, Binary, Duration, Categorical, and Vector linear types. The taxonomy may further be defined to include complex types, such as nested types, composite types, etc.

In one example, the processing logic may convert the complex object to a linearized object using a depth-first linearization algorithm. For example, the complex object may be represented as a tree of features in which composite features and nested type features include a child node and where the leaves of the tree are each linear features. Accordingly, to perform the depth-first linearization algorithm, the processing logic may traverse the tree in a depth-first manner, adding each feature to the linearized object as the tree is traversed. In this manner, the processing logic may linearize the complex object to the linearized set of features based on the defined taxonomy.

At block 430, the processing logic performs an explainability service on the application in view of the linearized set of features of the at least one complex object to generate an explanation array. In one example, the explainability service may be a LIME algorithm. The explanation array generated by the explainability service may include weights for each feature of the linearized set of features. The weights for each feature may be an importance score representing a likelihood of each feature being used in generating the output decision recommendation by the decision service. In one example, the processing logic may also convert the explanation array and the linearized set of features back to the original format of the one or more complex objects. For example, the processing logic may associate the weights for each feature with the corresponding feature in the original format of the complex objects. The processing logic may then provide an explanation of the output decision to a user of the decision service based on the importance score for each feature of the complex object.

FIGS. 5A and 5B depict block diagrams illustrating the linearization of a complex object 510 to a linearized object 520. As depicted in FIG. 5A, complex object 510 may include multiple features represented as a tree structure. Each feature of the complex object 510 may be of a type defined by a taxonomy associated with an application, such as a decision service. In some embodiments, the complex object 510 may be an input for the application to be analyzed by an explainability service (e.g., explainability service 115 of FIG. 1). Prior to performing the explainabilty service, a taxonomy converter (e.g., taxonomy converter 110 of FIG. 1) may convert the complex object 510 into a linearized set of features (e.g., linearized object 520).

In one example, the taxonomy may be defined to include several elementary types (e.g., String, Numeric, Boolean, URI, Time, Binary, Duration, Categorical, Vector, Currency, etc.) each representing a single type of linear feature. The taxonomy may further be defined to include complex types, such as nested types, composite types, etc. Nested types may be features that contain other features. Composite types may be features that represent multiple features. In one example, “feature A” may be a composite feature that includes “feature B,” “feature F,” and “feature G.” “Feature B” may be a nested type feature that includes “feature C” as a nested feature. “Feature C” may be a composite feature representing “feature D” and “feature E.” “Feature G” may be a composite feature representing “feature H” and “feature I.” Each of “feature D,” “feature E,” “feature F,” “feature H”, and “feature I” may be linear features of the taxonomy.

The taxonomy converter may use the taxonomy of the features included in the complex object 510 to convert the complex object 510 to the linearized object 520 as depicted in FIG. 5B. For example, the taxonomy converter may perform a depth-first linearization algorithm by traversing the feature tree of the complex object 510 in a depth-first manner, adding each feature to the linearized object 520 as the tree is traversed. Accordingly, the taxonomy converter may first traverse the tree from “feature A” a composite object, to “feature B” a hierarchical object, to “feature C” a composite object, to “feature D” a linear object. The taxonomy converter may then move “feature E”, another linear feature included in the composite “feature C.” Similarly, taxonomy continues to traverse the tree and add each of the features of the complex object 510 to the linearized object 520. The explainability service may then receive the linearized object 520 to generate an explanation of the application, as described above with respect to FIGS. 1-4.

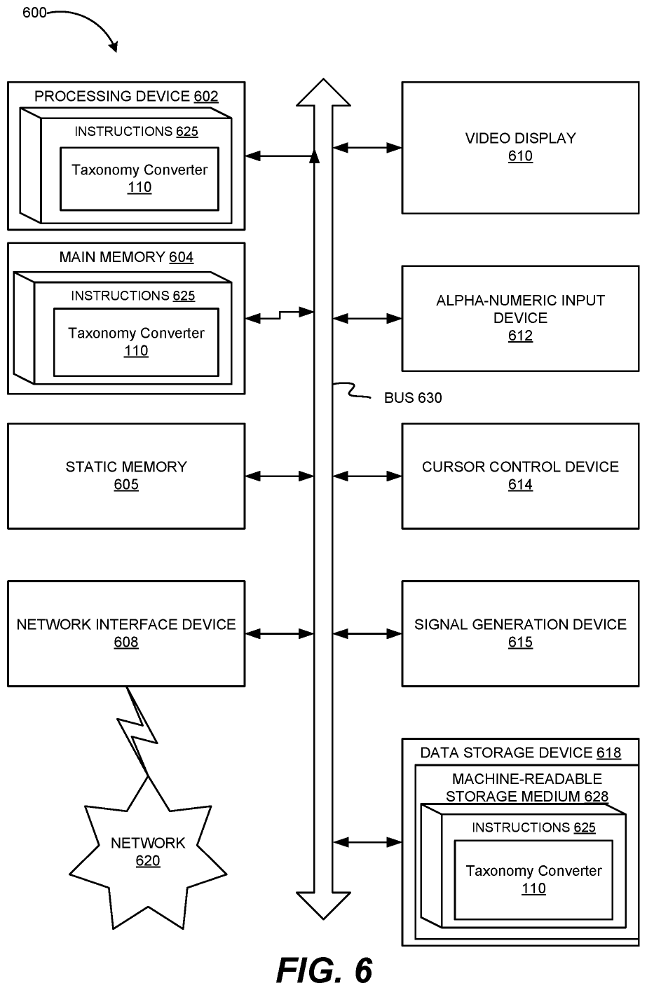

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a taxonomy converter, e.g., taxonomy converter 110, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving input data associated with an application, the input data comprising at least one complex object;
converting, by a processing device, the at least one complex objects of the input data to a linearized set of features; and
performing, by the processing device, an explainability service on the application in view of the linearized set of features of the at least one complex object to generate an explanation array.

2. The method of claim 1, further comprising:
converting the linearized set of features of the explanation array to an original format of the at least one complex object.

3. The method of claim 1, wherein the application is a decision service.

4. The method of claim 1, wherein the at least one complex object comprises at least one composite feature comprising a plurality of features or at least one nested type feature comprising a plurality of hierarchical features.

5. The method of claim 1, wherein converting the at least one complex object of the input data to the linearized set of features comprises:
determining a taxonomy associated with the application; and
converting the at least one complex object of the input data to the linearized set of features in view of the taxonomy.

6. The method of claim 1, wherein the explainability service is a local interpretable model-agnositic explanation (LIME) service.

7. The method of claim 1, wherein the explanation array comprises weights for each feature of the linearized set of features representing an importance of each corresponding feature in generating an output of the application from the input data.

8. A system comprising:
a memory; and
a processing device operatively coupled to the memory, the processing device to:
receive input data associated with an application, the input data comprising at least one complex object;
convert the at least one complex objects of the input data to a linearized set of features; and
perform an explainability service on the application in view of the linearized set of features of the at least one complex object to generate an explanation array.

9. The system of claim 8, wherein the processing device is further to:
convert the linearized set of features of the explanation array to an original format of the at least one complex object.

10. The system of claim 8, wherein the application is a decision service.

11. The system of claim 8, wherein the at least one complex object comprises at least one composite feature comprising a plurality of features or at least one nested type feature comprising a plurality of hierarchical features.

12. The system of claim 8, wherein converting the at least one complex object of the input data to the linearized set of features comprises:
determine a taxonomy associated with the application; and
convert the at least one complex object of the input data to the linearized set of features in view of the taxonomy.

13. The system of claim 8, wherein the explainability service is a local interpretable model-agnositic explanation (LIME) service.

14. The system of claim 8, wherein the explanation array comprises weights for each feature of the linearized set of features representing an importance of each corresponding feature in generating an output of the application from the input data.

15. A non-transitory computer-readable storage medium including instructions that, when executed by a processing device, cause the processing device to:
receive input data associated with an application, the input data comprising at least one complex object;
convert, by the processing device, the at least one complex objects of the input data to a linearized set of features; and
perform, by the processing device, an explainability service on the application in view of the linearized set of features of the at least one complex object to generate an explanation array.

16. The non-transitory computer-readable storage medium of claim 15, wherein the processing device is further to:
convert the linearized set of features of the explanation array to an original format of the at least one complex object.

17. The non-transitory computer-readable storage medium of claim 15, wherein the application is a decision service.

18. The non-transitory computer-readable storage medium of claim 15, wherein the at least one complex object comprises at least one composite feature comprising a plurality of features or at least one nested type feature comprising a plurality of hierarchical features.

19. The non-transitory computer-readable storage medium of claim 15, wherein converting the at least one complex object of the input data to the linearized set of features comprises:
determine a taxonomy associated with the application; and
convert the at least one complex object of the input data to the linearized set of features in view of the taxonomy.

20. The non-transitory computer-readable storage medium of claim 15, wherein the explainability service is a local interpretable model-agnositic explanation (LIME) service.
